(19) United States
(12) Patent Application Publication
(10) Pub. No.: US 2006/0054438 A1
(43) Pub. Date: Mar. 16, 2006

(54) Guide-equipped cylinder

(75) Inventors: Tsuyoshi Asaba, Abiko-shi (JP); Hiroyuki Okuhira, Moriya-shi (JP)

Correspondence Address: PAUL A. GUSS;PAUL A. GUSS ATTORNEY AT LAW, 775 S 23RD ST FIRST FLOOR SUITE 2, ARLINGTON, VA, 22202, US

(73) Assignee: SMC Kabushiki Kaisha, Tokyo (JP)

(21) Appl. No.: 11/217,389

(22) Filed: Sep. 2, 2005

(30) Foreign Application Priority Data
Sep. 13, 2004 (JP) 2004-264957

(51) Int. Cl. F16F 9/00

(52) U.S. Cl. 188/322.19

(57) ABSTRACT

A piston rod is inserted into a center hole of a cylinder tube of a guide-equipped cylinder. A first guide rod and a second guide rod, which are connected to the piston rod by a connecting plate, are inserted into a first side hole and a second side hole respectively. The first guide rod is inserted into respective through-holes of a first bush and a second bush. On the other hand, the second guide rod is inserted into respective through-holes of a third bush and a fourth bush. Each of side circumferential walls of the first guide rod and the second guide rod is coated with a coating. Each of inner circumferential walls of the bushes is coated with a coating.

### BACKGROUND OF THE INVENTION

1. Field of the Invention

The present invention relates to a guide-equipped cylinder in which one or more guide members guide a piston rod while making reciprocal movement.

2. Description of the Related Art

In general, a fluid pressure cylinder has a cylinder tube which is provided with a hole, and a piston rod which is operated in the hole by a pressure fluid such as compressed air and pressure oil. One end of the piston rod protrudes from the hole.

The piston rod is usually long and makes reciprocal movement in the axial direction. Therefore, when the load, which is directed perpendicularly to the axial direction (hereinafter referred to as “transverse load”), is applied to the tip end of the piston rod protruding from the hole, the other end of the piston rod inserted into the hole may undesirably be displaced in the direction opposite to the direction of the transverse load. That is, for example, in the case of the piston rod extending in the horizontal direction, when the transverse load, which is directed vertically downwardly, is applied to the tip end of the piston rod, the other end of the piston rod is displaced in a slight amount vertically upwardly in the cylinder tube depending on the magnitude of the transverse load.

In this case, the other end of the piston rod abuts against the side circumferential wall of the hole. As a result, a so-called stick-slip phenomenon may occur, in which it is difficult to cause the reciprocal movement of the piston rod. Further, if some larger load is applied, the piston rod may cause permanent set or permanent deformation.

Also, it is desired that the fluctuation in the fluid pressure cylinder is scarcely caused in the circumferential direction of the piston rod during the period in which the piston rod performs the reciprocal movement. In other words, a desirable fluid pressure cylinder is excellent in so-called non-rotational accuracy.

In view of the above, a guide-equipped cylinder, in which a piston rod is interposed by two guide rods and the piston rod and the guide rods are arranged in parallel, is widely adopted, for example, as described in Japanese Laid-Open Patent Publication No. 9-303318. The guide-equipped cylinder has two holes which are provided in the vicinity of the hole into which the piston rod is inserted. The guide rods are inserted into the respective holes so that the guide rods are capable of making the reciprocal movement by the aid of bushes. Tip ends of the piston rod and the guide rods, which protrude from the respective holes, are connected to one another by a connecting member such as a plate. Therefore, the guide rods and the plate make the reciprocal movement while following the reciprocal movement of the piston rod.

In the case of such a guide-equipped cylinder, the piston rod is connected to the guide rods via the connecting member. Accordingly, the displacement and the deformation are hardly caused even when the transverse load is applied. Further, it is extremely difficult to rotate the piston rod. Therefore, the non-rotational accuracy is improved as well.

When the guide-equipped cylinder as described above is used in an environment in which water droplets disperse or in an environment which is replete with steam, then the water droplets and the steam permeate into the cylinder tube, and they are discharged therefrom as the piston rod is moved reciprocally. As water comes in and out, the lubricant (grease or the like), which interposes between the guide rods and the bushes, may flow out. In such a situation, the frictional resistance is increased between the guide rods and the bushes. Therefore, the lubrication between the guide rods and the bushes may become defective, and scorch or galling (burnout) may be caused.

In the case of the guide-equipped cylinder, copper or iron is selected as a material for the bush in order to avoid the occurrence of the scorch or galling as much as possible. However, copper and iron are insufficient in the corrosion resistance in the environment in which water is present. Alternatively, when a bush made of resin is used, the friction resistance of the bush is small as compared with the metal.

### SUMMARY OF THE INVENTION

A general object of the present invention is to provide a guide-equipped cylinder which makes it possible to avoid the occurrence of scorch or galling even when the lubricant flows out.

A principal object of the present invention is to provide a guide-equipped cylinder which makes it possible to avoid the corrosion of bushes.

According to a first aspect of the present invention, there is provided a guide-equipped cylinder including a guide member which guides a piston rod by making reciprocal movement in a second hole of a cylinder tube in accordance with reciprocal movement of the piston rod inserted into a first hole of the cylinder tube, tip ends of the piston rod and the guide member being connected to one another by a connecting member, the guide-equipped cylinder comprising

a bush which is inserted into the second hole and which is provided with a through-hole for inserting the guide member thereinto, wherein

the guide member is composed of metal; and

the bush is composed of metal, and an inner wall of the through-hole is coated with a coating composed of nitride ceramics, carbide ceramics, or diamond-like carbon.

According to another aspect of the present invention, there is provided a guide-equipped cylinder including a guide member which guides a piston rod by making reciprocal movement in a second hole of a cylinder tube in accordance with reciprocal movement of the piston rod inserted into a first hole of the cylinder tube, tip ends of the piston rod and the guide member being connected to one another by a connecting member, the guide-equipped cylinder comprising

a bush which is inserted into the second hole and which is provided with a through-hole for inserting the guide member thereinto, wherein

the guide member is composed of metal having an outer wall surface coated with a coating composed of nitride ceramics, carbide ceramics, diamond-like carbon, or chromium plating; and

the bush is composed of metal.

According to still another aspect of the present invention, there is provided a guide-equipped cylinder including a guide member which guides a piston rod by making reciprocal movement in a second hole of a cylinder tube in accordance with reciprocal movement of the piston rod inserted into a first hole of the cylinder tube, tip ends of the piston rod and the guide member being connected to one another by a connecting member, the guide-equipped cylinder comprising

a bush which is inserted into the second hole and which is provided with a through-hole for inserting the guide member thereinto, wherein

the guide member is composed of metal having an outer wall surface coated with a coating composed of nitride ceramics, carbide ceramics, diamond-like carbon, or chromium plating; and

the bush is composed of metal, and an inner wall of the through-hole is coated with a coating composed of nitride ceramics, carbide ceramics, or diamond-like carbon.

In the present invention, metal is selected as the material for the bush and the guide member. Therefore, even when the guide-equipped cylinder is used in an environment in which water droplets disperse or in an environment which is replete with steam, the bush and the guide member are prevented from being corroded. That is, the corrosion resistance is extremely satisfactory for the bush and the guide member.

Further, in the present invention, the coating is provided on the inner wall of the bush which makes sliding contact with the guide member, and the lubrication performance is added thereby. Therefore, the abrasion resistance is improved for the bush and the guide member. Further, the occurrence of scorch or galling is avoided even in the case of the use of the bush composed of stainless steel which tends to cause scorch or galling as compared with copper and iron.

Alternatively, the outer wall surface of the guide member may be coated with nitride ceramics, carbide ceramics, diamond-like carbon, or chromium plating. Accordingly, the corrosion resistance is improved for the guide member as well. Further, even when both of the bush and the guide member are composed of metal, the occurrence of scorch or galling is avoided more appropriately, because the coating is present.

Preferred examples of the nitride ceramics usable as the material for the coating film may include any one of CrN, TiN, TiCN, and TiAlN. Preferred examples of the carbide ceramics may include any one of TiC and Cr₂C₃.

In any materials, one of the preferable metals for the bush or the guide member is stainless steel. Stainless steel is advantageous since it gives extremely high corrosion resistance.

The bush and the guide member may be made of other metals such as aluminum or aluminum alloy. If the bush and the guide member are made of aluminum or aluminum alloy, the entire guide-equipped cylinder can be reduced in weight, as well as the bush and the guide member.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic sectional view taken in the axial direction illustrating an entire guide-equipped cylinder according to an embodiment of the present invention;

FIG. 2 is a magnified sectional view illustrating major parts in which a guide rod and a bush of the guide-equipped cylinder shown in FIG. 1 are magnified;

FIG. 3 is a schematic sectional view illustrating the entire guide-equipped cylinder depicting a state in which a piston rod and the guide rods of the guide-equipped cylinder shown in FIG. 1 are subjected to the forward movement until arrival at the most frontward end;

FIG. 4 shows a graph illustrating the change of the maximum height Rz before and after a sliding contact test;

FIG. 5 shows a graph illustrating the time-dependent change of the coefficient of friction in the sliding contact test; and

FIG. 6 shows a table illustrating the performance of each of guide-equipped cylinders manufactured by changing the material for the bush.

### DESCRIPTION OF THE PREFERRED EMBODIMENTS

The guide-equipped cylinder according to the present invention will be exemplified by preferred embodiments below, which will be explained in detail with reference to the accompanying drawings.

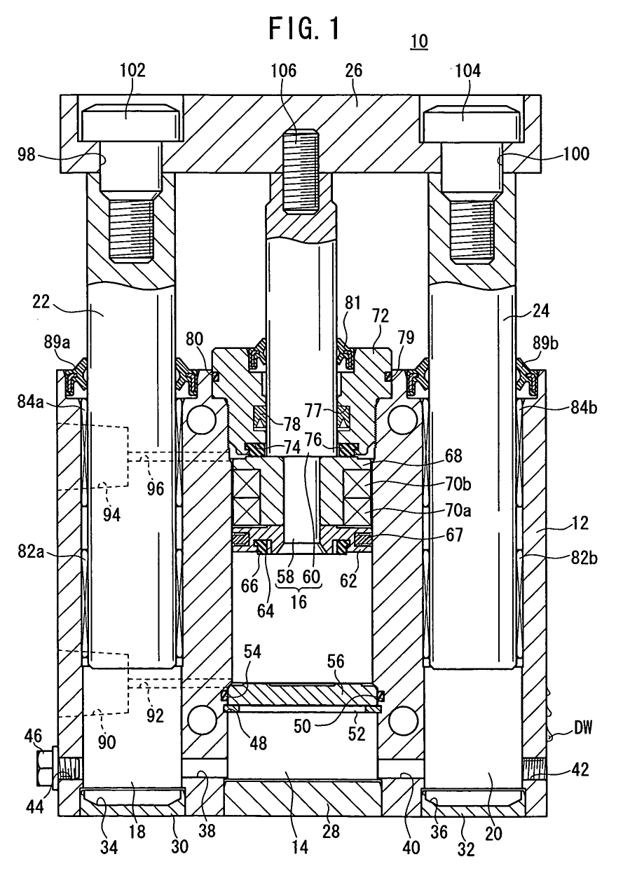

FIG. 1 shows a schematic sectional view taken in the axial direction illustrating an entire guide-equipped cylinder according to an embodiment of the present invention. The guide-equipped cylinder 10 comprises a cylinder tube 12, a piston rod 16 which is inserted into a center hole (first hole) 14 provided in the cylinder tube 12 so that the piston rod 16 is capable of making reciprocal movement, and a first guide rod 22 and a second guide rod 24 (both are guide members) which are made of stainless steel and which are inserted into a first side hole 18 and a second side hole 20 (both are second holes) provided in the vicinity of thereof to interpose the center hole 14 therebetween so that the first guide rod 22 and the second guide rod 24 are capable of making reciprocal movement respectively. One end of each of the piston rod 16, the first guide rod 22, and the second guide rod 24 protrudes from each of the center hole 14, the first side hole 18, and the second side hole 20. The tip ends thereof are connected to one another by the aid of a connecting plate 26 as a connecting member. FIG. 1 shows a state in which the piston rod 16, the first guide rod 22, and the second guide rod 24 are positioned at the most backward end.

The center hole 14, the first side hole 18, and the second side hole 20 are provided to penetrate through the cylinder tube 12. Lower openings of the holes 14, 18, 20 as shown in FIG. 1 are closed by a first cap member 28, a second cap member 30, and a third cap member 32. Recesses 34, 36 are formed on surfaces of the second cap member 30 and the third cap member 32 facing the first guide rod 22 and the second guide rod 24, respectively. The respective tip end surfaces of the first guide rod 22 and the second guide rod 24, which have made the frontward movement until arrival at the most front ends, are prevented from the abutment against the second cap member 30 and the third cap member 32 by the recesses 34, 36.

The cylinder tube 12 is provided with a first communication passage 38 which makes communication between the first side hole 18 and the center hole 14, and a second communication passage 40 which makes communication between the center hole 14 and the second side hole 20. An open port 42, which is engraved with a screw section and which is open to the atmospheric air, is communicated with the second side hole 20. That is, the first side hole 18, the center hole 14, and the second side hole 20 are open to the atmospheric air via the open port 42.

A port 44, which is communicated with the first side hole 18, is closed by a bolt 46.

A first annular groove 48 is formed in the vicinity of the first communication passage 38 and the second communication passage 40 in the center hole 14. A second annular groove 50 is provided at a position slightly over the first annular groove 48 as shown in FIG. 1. A seal member 52, which has a substantially C-shaped cross section, is fitted to the first annular groove 48. On the other hand, an 0-ring 54 is inserted into the second annular groove 50. A substantially disk-shaped closing member 56 is positioned to close the second annular groove 50.

The piston rod 16, which is inserted into the center hole 14, has a small diameter section 58 and a long and large diameter section 60 which are disposed in this order in the direction from the side of the first communication passage 38 and the second communication passage 40 to the side of the connecting plate 26. In particular, a substantially disk-shaped piston 62 is connected to a circumferential wall of the small diameter section 58 disposed on the side of the tip end.

The piston 62 has a first accommodating annular groove 64 which has an inverse L-shaped cross section and which is disposed on the end surface on the side facing the closing member 56. A first rubber damper 66, which has an inverse L-shaped cross section, is installed in the first accommodating annular groove 64. A horizontal portion of the first rubber damper 66 is fitted to a horizontal portion of the first accommodating annular groove 64. Accordingly, the first rubber damper 66 is prevented from any disengagement from the first accommodating annular groove 64. The tip end of the first rubber damper 66 slightly protrudes from the first accommodating annular groove 64. An O-ring 67 is accommodated in an annular recess provided on the side circumferential wall of the piston 62.

A pressure-receiving member 68 is interposed between the piston 62 and the large diameter section 60. The pressure-receiving member 68 has a small diameter section which is fitted to through-holes of magnets 70a, 70b. The fitting retains the magnets 70a, 70b in the small diameter section of the pressure-receiving member 68.

A screw section is engraved in the vicinity of the upper opening of the center hole 14. A screw section of a fourth cap member 72 for closing the center hole 14 is engaged with the screw section. The upper end surface of the fourth cap member 72 protrudes from the center hole 14.

A second accommodating annular groove 74, which has an inverse L-shaped cross section, is provided at the end surface on the side facing the pressure-receiving member 68 of the fourth cap member 72 in the same manner as in the piston 62. A second rubber damper 76, which has an inverse L-shaped cross section, is installed in the second accommodating annular groove 74. The second rubber damper 76 is also accommodated in the second accommodating annular groove 74 in the same manner as the first rubber damper 66. Further, the second rubber damper 76 slightly protrudes from the second accommodating annular groove 74.

An annular cutout 77 is provided to face the piston rod 16 at a substantially halfway portion of the fourth cap member 72 in the axial direction of the piston rod 16. A seal member 78 is accommodated in the annular cutout 77.

An annular groove 79 is also formed on the side circumferential wall of a large diameter section of the fourth cap member 72. An O-ring 80 is inserted into the annular groove 79. A recess is provided at the upper end surface of the fourth cap member 72 protruding from the center hole 14. A first scraper 81, which also functions as a seal, is accommodated in the recess.

On the other hand, a first bush 82a and a second bush 84a are positioned and fixed in the first side hole 18. The first guide rod 22 is inserted into through-holes of the first bush 82a and the second bush 84a. Therefore, when the first guide rod 22 makes the reciprocal movement, the side circumferential wall of the first guide rod 22 makes sliding contact with the inner circumferential walls of the first bush 82a and the second bush 84a.

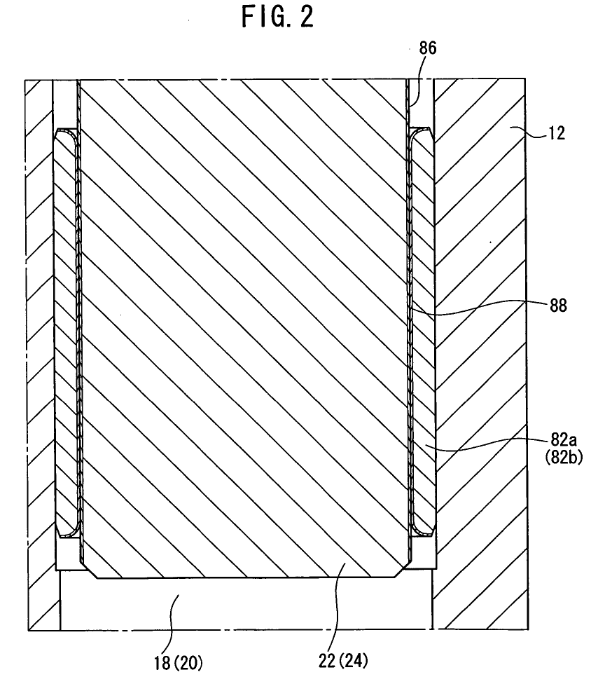

The inner circumferential wall of the first bush 82a and the side circumferential wall of the first guide rod 22 are now magnified and shown in FIG. 2. As shown in FIG. 2, the side circumferential wall of the first guide rod 22 is coated with a coating 86, and the inner circumferential wall of the first bush 82a is coated with a coating 88.

Materials for the coatings 86, 88 are excellent in the lubrication performance although they are hard in quality. Specifically, nitride ceramics, carbide ceramics, and diamond-like carbon (DLC) are selected. Preferred examples of the nitride ceramics include, for example, CrN, TiN, TiCN, and TiAlN, and preferred examples of the carbide ceramics include, for example, TiC and Cr₂C₃. However, materials are not limited to these.

The coatings 86, 86 are provided, for example, by means of an ion plating method. In this procedure, it is possible to set the film thickness to be extremely small, i.e., about 2 to 5 μm.

On the other hand, the inner circumferential wall of the second bush 84a is also coated with the coating 88 in the same manner as in the first bush 82a.

As shown in FIG. 1, the first side hole 18 is open at an upper portion of the cylinder tube 12 shown in FIG. 1. A second scraper 89a is accommodated in the opening.

The remaining second side hole 20 is constructed in the same manner as the first side hole 18. Therefore, reference numerals of a third bush and a fourth bush accommodated in the second side hole 20 and a third scraper accommodated in the opening are designated as 82b, 84b, and 89b obtained by replacing, with “b”, the subscripts “a” of the reference numerals of the first bush 82a, the second bush 84a, and the second scraper 89a, and the detailed explanation thereof is omitted. Of course, the side circumferential wall of the second guide rod 24 and the inner circumferential walls of the third bush 82b and the fourth bush 84b accommodated in the second side hole 20 are also coated with the coatings 86, 88 (see FIG. 2).

In the guide-equipped cylinder 10 constructed as described above, the cylinder tube 12 is provided with a first port 90 and a first passage 92 for supplying/discharging the pressure fluid with respect to a first chamber formed between the closing member 56 and the piston 62, and a second port 94 and a second passage 96 for supplying/discharging the pressure fluid with respect to a second chamber formed between the pressure-receiving member 68 and the fourth cap member 72 (see FIG. 1).

The connecting plate 26 is provided with a first through-hole 98 and a second through-hole 100. Bolts 102, 104, which are inserted into the first through-hole 98 and the second through-hole 100, are engaged with bolt holes formed at the tip end portions of the first guide rod 22 and the second guide rod 24. Accordingly, the first guide rod 22 and the second guide rod 24 are connected to the connecting plate 26.

The connecting plate 26 and the piston rod 16 are connected to one another by the aid of a headless bolt 106 which is engaged with a bolt hole provided in the connecting plate 26 and a bolt hole provided at the end surface of the piston rod 16.

An unillustrated displacement sensor is installed on the outer wall of the cylinder tube 12.

The guide-equipped cylinder 10 according to the embodiment of the present invention is basically constructed as described above. Next, its operation, function, and effect will be explained.

The guide-equipped cylinder 10 is installed, for example, at a workplace such as a food processing line in which water droplets disperse and/or steam is produced.

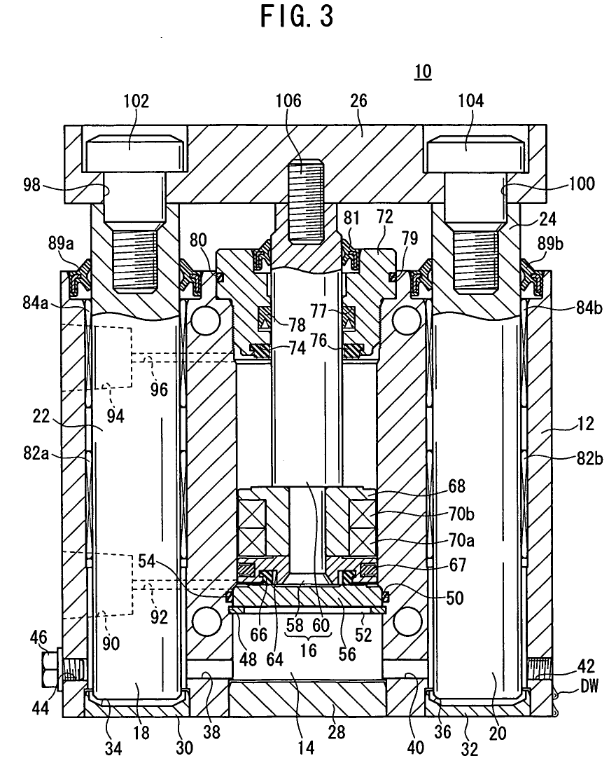

In such a workplace, when the piston rod 16 is moved downwardly from the state shown in FIG. 1 to provide the state shown in FIG. 3, in other words, when the piston rod 16 is moved frontwardly, then the pressure fluid is supplied from the second port 94 via the second passage 96 to the second chamber. The pressure-receiving member 68 receives the pressing action effected by the pressure fluid. As a result, the pressure-receiving member 68 as well as the piston rod 16 for retaining the pressure-receiving member 68 is moved downwardly. Finally, the piston 62, which is retained at the tip end of the small diameter section 58 of the piston rod 16, is moved downwardly.

The piston 62 is moved downwardly to the position in the vicinity of the closing member 56. During this process, even when the speed of the downward movement of the piston 62 is extremely large, and the first rubber damper 66 abuts against the closing member 56, then the impact, which is exerted upon the abutment, is greatly reduced, because the first rubber damper 66 functions as the buffer member.

The pressure fluid contained in the first chamber is discharged to the outside of the cylinder tube 12 via the first passage 92 and the first port 90 as the piston 62 is moved downwardly.

The first guide rod 22 and the second guide rod 24, which are connected to the piston rod 16 by the aid of the connecting plate 26, are moved downwardly while following the downward movement of the piston 62. The air contained in the first side hole 18 and the second side hole 20, which is pressed thereby, is discharged to the atmosphere via the first communication passage 38, the chamber between the first cap member 28 and the closing member 56 in the center hole 14, the second communication passage 40, and the open port 42.

During this process, the side circumferential wall of the first guide rod 22 makes sliding contact with the respective inner circumferential walls of the first bush 82a and the second bush 84a, while the side circumferential wall of the second guide rod 24 makes sliding contact with the respective inner circumferential walls of the third bush 82b and the fourth bush 84b.

On the other hand, when the piston rod 16 is moved upwardly from the state shown in FIG. 3 to make restoration to the state shown in FIG. 1 (when the piston rod 16 is moved backwardly), the pressure fluid is supplied from the first port 90 via the first passage 92 to the first chamber. The lower end surface of the piston 62 shown in FIG. 3 receives the pressing action effected by the pressure fluid, and thus the piston rod 16 is finally moved upwardly. During this process, the pressure fluid contained in the second chamber is discharged to the outside of the cylinder tube 12 via the second passage 96 and the second port 94.

When the piston 62 is moved upwardly, the first guide rod 22 and the second guide rod 24, which are connected to the piston rod 16 by the aid of the connecting plate 26, are also moved upwardly. Accordingly, the atmospheric air existing around the cylinder tube 12, the water droplets DW, and the steam are introduced into the first side hole 18 and the second side hole 20 via the first communication passage 38, the chamber between the first cap member 28 and the closing member 56 in the center hole 14, the second communication passage 40, and the open port 42. The water droplets DW and the steam adhere to the side circumferential walls of the first guide rod 22 and the second guide rod 24. In this state, the side circumferential wall of the first guide rod 22 makes sliding contact with the inner circumferential walls of the first bush 82a and the second bush 84a, while the side circumferential wall of the second guide rod 24 makes sliding contact with the inner circumferential walls of the third bush 82b and the fourth bush 84b.

However, in the embodiment of the present invention, both of the first guide rod 22 and the second guide rod 24 are formed of stainless steel. The stainless steel exhibits extremely excellent durability against water. That is, the stainless steel exhibits excellent corrosion resistance. Therefore, the first guide rod 22 and the second guide rod 24 are prevented from the corrosion which would be otherwise caused by the steam and the water droplets DW.

When the dust or the like adheres to the side circumferential walls of the piston rod 16, the first guide rod 22, and the second guide rod 24, the dust or the like is disengaged therefrom by the first scraper 81, the second scraper 89a, and the third scraper 89b. When the upward movement speed of the piston 62 is extremely large, and the second rubber damper 76 abuts against the fourth cap member 72, the impact is greatly reduced upon the abutment, because the second rubber damper 76 functions as the buffer member.

In the operation as described above, the downward movement and the upward movement of the piston rod 16 are monitored by sensing, with the displacement sensor, the displacement of the magnets 70a, 70b together with the piston rod 16.

When the piston rod 16, the first guide rod 22, and the second guide rod 24 are moved downwardly again, part of the water droplets DW and the steam permeated into the first side hole 18 and the second side hole 20 flow out from the open port 42. During this process, part of the lubricant introduced into the first side hole 18 and the second side hole 20 is accompanied. Therefore, the lubricant may undesirably flow out as the piston rod 16 repeats the reciprocal movement as described above.

However, in this case, as described above, the side circumferential wall portions of the first guide rod 22 and the second guide rod 24 are coated with the coating 86, and the respective inner circumferential walls of the first bush 82a, the second bush 84a, the third bush 82b, and the fourth bush 84b are coated with the coating 88 (see FIG. 2). The lubrication performance is retained by the coatings 86, 88. Therefore, even if a large amount of the lubricant flows out, it is possible to avoid the occurrence of scorch or galling (burnout).

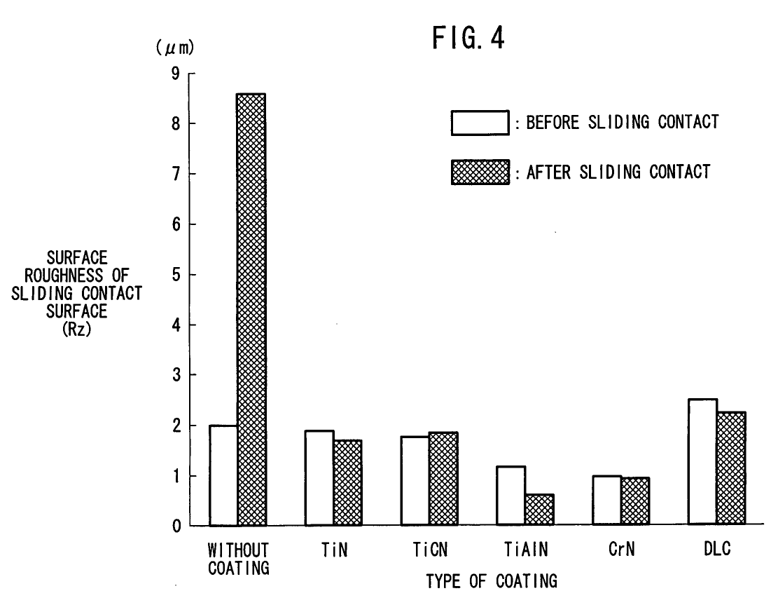

For testing, various coatings were applied to provide film thicknesses of 2 to 3 μm to both of a block member and a plate member composed of stainless steel. The block member was allowed to make sliding contact with the upper end surface of the plate member on condition that the load was 30 N (surface pressure: 3.1×10⁻⁴ N/m²), and the movement distance was 50 m. The change of the maximum height Rz (see JIS B0601) before and after sliding contact was investigated. Obtained results are shown in FIG. 4. According to FIG. 4, it is clear that the change of Rz is suppressed, in other words, the abrasion is suppressed by providing the coating.

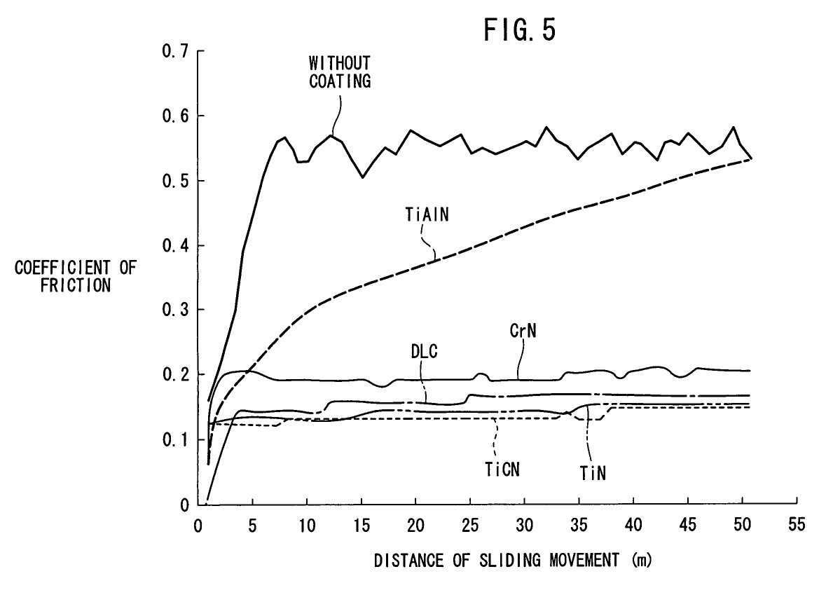

Further, the time-dependent change of the coefficient of friction in this test was measured. Obtained results are shown in FIG. 5 in combination. In this test, when the coating was not provided, then the coefficient of friction was quickly increased immediately after the start of the test, and the abnormal frictional sound was made at a point of time at which the distance of sliding movement exceeded 10 m. When the TiAlN coating film was provided, then the coefficient of friction was also increased, but no abrasion was observed as shown in FIG. 4.

According to the test results shown in FIGS. 4 and 5 as described above, the following is appreciated. Even when the stainless steel, with which the scorch or galling is caused more frequently as compared with copper and iron, is adopted as the materials for the first guide rod 22, the second guide rod 24, the first bush 82a, the second bush 84a, the third bush 82b, and the fourth bush 84b, then the lubrication is given by providing the coatings 86, 88, and thus it is possible to avoid the occurrence of scorch or galling.

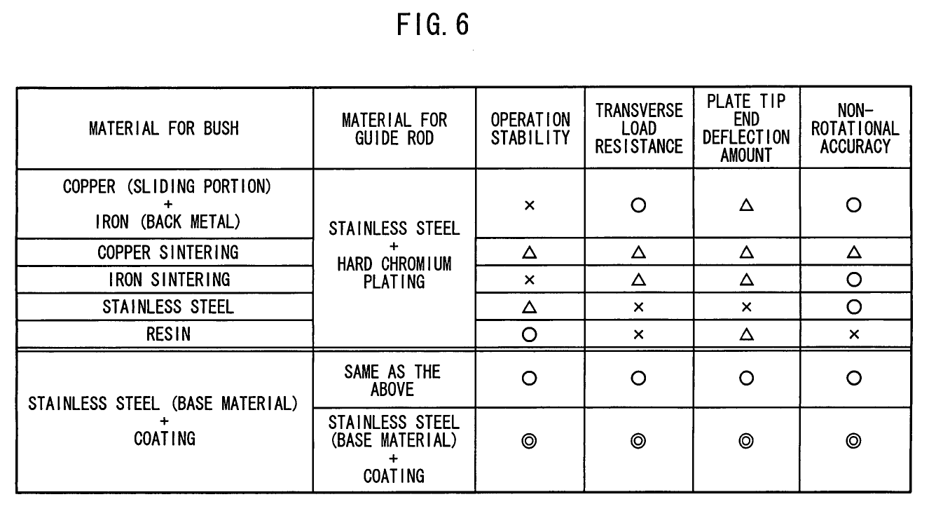

For the purpose of comparison, guide-equipped cylinders were manufactured, which were constructed in the same manner as the guide-equipped cylinder 10 described above except that: those other than the stainless steel were used as materials for the first bush 82a, the second bush 84a, the third bush 82b, and the fourth bush 84b; the coating 88 was not provided; and the chromium plating was provided as the coating 86 for the first guide rod 22 and the second guide rod 24. FIG. 6 shows the performance while making comparison between the respective types of the guide-equipped cylinders constructed as described above and the guide-equipped cylinder 10 according to the embodiment of the present invention.

In FIG. 6, the “operation stability” is judged by whether or not the stick-slip phenomenon tends to be caused. As for the symbols, a cross means the fact that the stick-slip phenomenon tends to be caused and the operation stability is not satisfactory. The symbols of a triangle, a circle, and a double circle indicate that the stick-slip phenomenon is hardly caused and the operation stability is satisfactory. The double circle indicates the best result, and the circle indicates a better result than the triangle. The “transverse load resistance” is judged by whether or not the displacement tends to be caused by the transverse load. The symbols of a cross, a triangle, a circle, and a double circle indicate the degree of the displacement. The cross indicates the worst result, and the double circle indicates the best result that the displacement is hardly caused. The circle indicates a better result than the triangle.

The “plate tip end deflection amount” indicates the magnitude of the displacement amount of the plate in the vertical direction when the guide-equipped cylinder is attached so that the axial direction is in the horizontal direction. The symbol of the cross indicates the worst result, and the double circle indicates the best result that the displacement amount is the smallest. The circle indicates a better result than the triangle. The remaining “non-rotational accuracy” indicates the magnitude of the fluctuation of the piston rod in the rotational direction. The symbol of the cross indicates the worst result, and the double circle indicates the best result that the fluctuation amount is the smallest, in other words, the non-rotational accuracy is improved. The circle indicates a better result than the triangle.

According to FIG. 6, the guide-equipped cylinder 10, which is excellent in the respective performances as described above, is constructed by using stainless steel as the materials for the first bush 82a, the second bush 84a, the third bush 82b, the fourth bush 84b, the first guide rod 22, and the second guide rod 24, and forming the coatings 86, 88 at the sliding contact portions therebetween.

As described above, in the embodiment of the present invention, the stainless steel is selected as the materials for the first guide rod 22, the second guide rod 24, the first bush 82a, the second bush 84a, the third bush 82b, and the fourth bush 84b. Therefore, even when the guide-equipped cylinder 10 is used in an environment in which the water droplets DW disperse or in an environment which is replete with the steam, the first guide rod 22, the second guide rod 24, the first bush 82a, the second bush 84a, the third bush 82b, and the fourth bush 84b are prevented from any corrosion.

Further, the side circumferential walls of the first guide rod 22 and the second guide rod 24 and the inner circumferential walls of the first bush 82a, the second bush 84a, the third bush 82b, and the fourth bush 84b, i.e., the sliding contact portions therebetween are coated with the coatings 86, 88. Therefore, even when the stainless steel, which tends to cause the scorch or galling as compared with iron and copper, is selected as the materials for the first guide rod 22, the second guide rod 24, the first bush 82a, the second bush 84a, the third bush 82b, and the fourth bush 84b, it is possible to avoid the occurrence of the scorch or galling.

The embodiment described above is illustrative of the case in which the coating 86, which is composed of nitride ceramics, carbide ceramics, or diamond-like carbon, is provided on the side circumferential walls of the first guide rod 22 and the second guide rod 24. However, as appreciated from FIG. 6, the coating 86, which is composed of chromium plating, may be formed in place of the above.

Alternatively, one guide rod may be provided, or three or more guide rods may be provided.

Furthermore, in the embodiment of the present invention, the first guide rod 22, the second guide rod 24, the first bush 82a, the second bush 84a, the third bush 82b, and the fourth bush 84b are made of stainless steel. However, the material for these components is not limited to stainless steel, but the components can be made of other metals. For example, aluminum or aluminum alloy can preferably be used for the material for the components.

While the invention has been particularly shown and described with reference to preferred embodiments, it will be understood that variations and modifications can be effected thereto by those skilled in the art without departing from the spirit and scope of the invention as defined by the appended claims.

What is claimed is:

1. A guide-equipped cylinder including a guide member which guides a piston rod by making reciprocal movement in a second hole of a cylinder tube in accordance with reciprocal movement of said piston rod inserted into a first hole of said cylinder tube, tip ends of said piston rod and said guide member being connected to one another by a connecting member, said guide-equipped cylinder comprising
a bush which is inserted into said second hole and which is provided with a through-hole for inserting said guide member thereinto, wherein
said guide member is composed of metal; and
said bush is composed of metal, and an inner wall of said through-hole is coated with a coating composed of nitride ceramics, carbide ceramics, or diamond-like carbon.

2. The guide-equipped cylinder according to claim 1, wherein said nitride ceramics is any one of CrN, TiN, TiCN, and TiAlN.

3. The guide-equipped cylinder according to claim 1, wherein said carbide ceramics is TiC or Cr₂C₃.

4. The guide-equipped cylinder according to claim 1, wherein said guide member and said bush are composed of stainless steel.

5. The guide-equipped cylinder according to claim 1, wherein said guide member and said bush are composed of aluminum or aluminum alloy.

6. A guide-equipped cylinder including a guide member which guides a piston rod by making reciprocal movement in a second hole of a cylinder tube in accordance with reciprocal movement of said piston rod inserted into a first hole of said cylinder tube, tip ends of said piston rod and said guide member being connected to one another by a connecting member, said guide-equipped cylinder comprising
a bush which is inserted into said second hole and which is provided with a through-hole for inserting said guide member thereinto, wherein
said guide member is composed of metal having an outer wall surface coated with a coating composed of nitride ceramics, carbide ceramics, diamond-like carbon, or chromium plating; and
said bush is composed of metal.

7. The guide-equipped cylinder according to claim 6, wherein said nitride ceramics is any one of CrN, TiN, TiCN, and TiAlN.

8. The guide-equipped cylinder according to claim 6, wherein said carbide ceramics is TiC or Cr₂C₃.

9. The guide-equipped cylinder according to claim 6, wherein said guide member and said bush are composed of stainless steel.

10. The guide-equipped cylinder according to claim 6, wherein said guide member and said bush are composed of aluminum or aluminum alloy.

11. A guide-equipped cylinder including a guide member which guides a piston rod by making reciprocal movement in a second hole of a cylinder tube in accordance with reciprocal movement of said piston rod inserted into a first hole of said cylinder tube, tip ends of said piston rod and said guide member being connected to one another by a connecting member, said guide-equipped cylinder comprising
a bush which is inserted into said second hole and which is provided with a through-hole for inserting said guide member thereinto, wherein
said guide member is composed of metal having an outer wall surface coated with a coating composed of nitride ceramics, carbide ceramics, diamond-like carbon, or chromium plating; and
said bush is composed of metal, and an inner wall of said through-hole is coated with a coating composed of nitride ceramics, carbide ceramics, or diamond-like carbon.

12. The guide-equipped cylinder according to claim 11, wherein said nitride ceramics is any one of CrN, TiN, TiCN, and TiAlN.

13. The guide-equipped cylinder according to claim 11, wherein said carbide ceramics is TiC or Cr₂C₃.

14. The guide-equipped cylinder according to claim 11, wherein said guide member and said bush are composed of stainless steel.

15. The guide-equipped cylinder according to claim 11, wherein said guide member and said bush are composed of aluminum or aluminum alloy.
